(19) United States
(12) Patent Application Publication
(10) Pub. No.: US 2018/0211809 A1
(43) Pub. Date: Jul. 26, 2018

(54) CATHODE HEAD WITH MULTIPLE FILAMENTS FOR HIGH EMISSION FOCAL SPOT

(71) Applicant: VAREX IMAGING CORPORATION, Salt Lake City, UT (US)

(72) Inventors: James E. Burke, Salt Lake City, UT (US); Santosh Ramachandran, Salt Lake City, UT (US); Evgeny Galyaev, Salt Lake City, UT (US); Christopher Lewis, Kaysville, UT (US); Jacob Sullivan, Syracuse, UT (US)

(21) Appl. No.: 15/717,298

(22) Filed: Sep. 27, 2017

Related U.S. Application Data
(60) Provisional application No. 62/451,051, filed on Jan. 26, 2017.

(51) Int. Cl. H01J 35/06; H01J 35/14

(52) U.S. Cl. CPC H01J 35/06; H01J 35/14

(57) ABSTRACT

In some example embodiments, a cathode for an X-ray tube may include a first electron emitter and a second electron emitter spaced apart from the first electron emitter. The cathode may include a cathode body defining a first recess and a second recess. The first recess may have the first electron emitter positioned at least partially therein and the second recess may have the second electron emitter positioned at least partially therein. The second electron emitter may extend further out of the second recess than the first electron emitter extends out of the first recess. The first electron emitter and the second electron emitter may be configured to simultaneously direct electrons to a target on an anode.

### CROSS-REFERENCE TO RELATED APPLICATIONS

This application claims the benefit of U.S. Provisional Patent Application No. 62/451,051, filed Jan. 26, 2017, which is incorporated herein by reference in its entirety.

### BACKGROUND

The present disclosure generally relates to X-ray tubes, including embodiments relating to cathode heads for X-ray tubes.

X-ray tubes are used in a variety of industrial and medical applications. For example, X-ray tubes are employed in medical diagnostic examination, therapeutic radiology, semiconductor fabrication, and material analysis. More specifically, X-ray tubes are often used in computed tomography (CT) or X-ray imaging systems to analyze patients in medical imaging procedures or objects during package scanning.

During operation of a typical X-ray tube, an electrical current may be supplied to an electron emitter or filament of a cathode. This causes electrons to be formed on the emitter via a process known as thermionic emission. The electrons accelerate from the emitter toward a target track formed on the anode in the presence of a high voltage differential applied between the anode and the cathode. Upon striking the anode, some of the resulting kinetic energy from the striking electrons is converted into X-rays. The region of the anode upon which the majority of the electrons collide is generally referred to as a “focal spot.” The resulting X-rays may then pass through an X-ray transmissive window and are directed towards patient or other object to be examined. In a typical environment, an image is provided based on the X-rays that pass through the patient/object. While a number of factors affect the quality of a resulting image, one factor is the size, quality and/or energy level of the electrons in the focal spot region.

The claimed subject matter is not limited to embodiments that solve any disadvantages or that operate only in environments such as those described above. This background is only provided to illustrate examples of where the present disclosure may be utilized.

### BRIEF DESCRIPTION OF THE DRAWINGS

FIG. 1A is a perspective view of an example X-ray tube.

FIG. 1B is a side view of the X-ray tube of FIG. 1A.

FIG. 1C is a cross-sectional view of the X-ray tube of FIG. 1A.

FIG. 2 is a perspective view of an embodiment of a cathode assembly.

FIG. 3A is a perspective view of an embodiment of a cathode head.

FIG. 3B is a cross-section view of the cathode head of FIG. 3A.

FIG. 3C is a schematic representation of a focal spot created by the cathode head of FIG. 3A.

FIG. 3D is a diagram of focal spot intensity on a target.

FIG. 4A is a perspective view of an embodiment of a cathode head.

FIG. 4B is a cross-section view of the cathode head of FIG. 4A.

FIG. 5A is a top perspective view of an embodiment of a cathode head.

FIG. 5B is a bottom perspective view of the cathode head of FIG. 5A.

FIG. 5C is a cross-section view of the cathode head of FIG. 5A.

FIG. 6A is a top perspective view of an embodiment of a cathode head.

FIG. 6B is a bottom perspective view of the cathode head of FIG. 6A.

FIG. 6C is a cross-section view of the cathode head of FIG. 6A.

### DETAILED DESCRIPTION

Reference will be made to the drawings and specific language will be used to describe various aspects of the disclosure. Using the drawings and description in this manner should not be construed as limiting its scope. Additional aspects may be apparent in light of the disclosure, including the claims, or may be learned by practice.

In an X-ray tube, electrons are typically generated using an electron emitter, typically implemented with a filament of a cathode. In the presence of a voltage differential, the electrons may then be directed to a focal spot or a target on an anode, and upon striking the target, some of the resulting energy generated from the electron collision with the anode is converted into X-rays. The X-rays generated by the X-ray tube may then be directed to a patient or an object for analysis or treatment.

In some circumstances, it may be desirable to increase the amount of electrons produced by the cathode, or increase the rate that electrons are emitted by the cathode. This increases the number of electrons striking the anode, thereby increasing the amount of X-rays generated and emitted from the X-ray tube. Increasing the X-rays emitted from the X-ray tube may provide various advantages for X-ray imaging. For example, increasing the rate of X-ray emission may be used for quicker scanning of objects or patients.

The amount of electrons produced by the cathode may depend on various characteristics of the X-ray tube. For example, electron emission may be increased by increasing the surface area of the filament. The surface area of the filament may be increased by changing the dimensions of the filament, such as the size or shape of the filament. In another example, electron emission may be increased by increasing the current supplied to the filament. In yet another example, electron emission may be increased by increasing the voltage (or voltage differential) of the X-ray tube.

In practice, X-ray tube design is often constrained by restrictions on cost, manufacturing limitations, and compatibility with existing X-ray tubes and imaging systems. Accordingly, it many circumstances it not be suitable to increase the electrons, for example, by increasing current supplied to the filament, increasing the voltage of the X-ray tube, or increasing the size or the surface area of the filament. Furthermore, X-ray tubes may be inherently limited by space charge limitations for certain dimensions of filaments, cathode size, anode size, and spacing therebetween, such that increasing filament current may not produce increased X-ray emission.

One type of filament used in X-ray tubes is a coil filament. A coil filament is typically formed of a wire arranged in a spiral or helical configuration. Another type of filament that may be used in X-ray tubes is a flat or planar filament. One advantage of coil filaments is lower cost and widespread use in X-ray tubes. Another advantage of coil filaments is a better capability to selectively “cut off” the electron beam at a lower voltage, as will be describe in greater detail herein. Accordingly, in some circumstances it may be advantageous to implement coil filaments in X-ray tubes.

In some circumstances it may not be practicable to increase electron emission from a filament, for example, by increasing the size or surface area of a filament, because this would increase the size of the focal spot on the anode, which could decrease X-ray image quality. In another example, increasing the current to a filament may not be practicable because this could also enlarge the focal spot to an unsuitable size for some imaging applications. Furthermore, increasing the current to a filament may decrease the operating life of the filament.

In addition, many X-ray tubes include configurations that steer or focus the stream of electrons. For example, some X-ray tubes steer the electron beam by applying a grid voltage to components on or around the cathode. However, in some configurations, it may be impractical to increase the electron beam by increasing the size of the filament or current supplied to the filament, because this may significantly increase the grid voltage required to effectively steer the electron beam.

The disclosed embodiments may facilitate increasing the number of electrons produced by the cathode, and/or increasing the rate that electrons are emitted by the cathode. In some embodiments, the cathode may include two or more filaments that simultaneously produce electrons that are directed to the same focal spot and/or focal spot region. The cathode produces an increased number of electrons by simultaneously directing the electrons produced by both filaments to the same focal spot and/or same focal spot region. Such configurations may permit electron emission to be increased without increasing the surface area of either one of the filaments. Such configurations may also permit electron emission to be increased without changing the shape of either one of the filaments. Additionally or alternatively, such configurations may permit electron emission to be increased without increasing the current supplied to the filament or the voltage of the X-ray tube. Furthermore, such configurations may be implemented using low-cost coil filaments.

The disclosed embodiments may also improve the imaging characteristics of the X-ray tube. For example, the disclosed embodiments may produce a focal spot with greater intensity, which may lead to faster scanning time and/or better imaging penetration. In another example, the disclosed embodiments may produce a focal spot on the anode that has a more uniformly distributed intensity, which improves image resolution.

In addition, the disclosed embodiments may facilitate steering of the electron beams produced by the cathode. For example, since the size of the filaments or the current supplied to the filaments is not increased, increasing the grid voltage is not necessary to steer the electron beams.

Previous cathode designs have included multiple filaments, however, in previous configurations each of the filaments were activated alternately. In such configurations, only one of the filaments was activated at a time, and electron emission from one filament would cease before the electrons are emitted from the other filament.

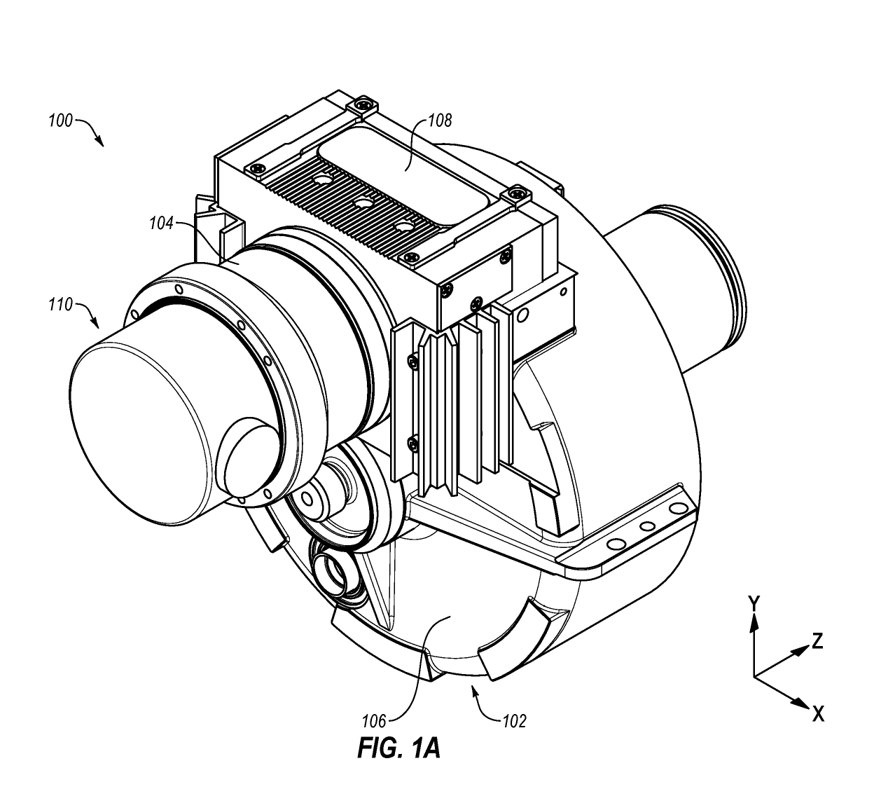

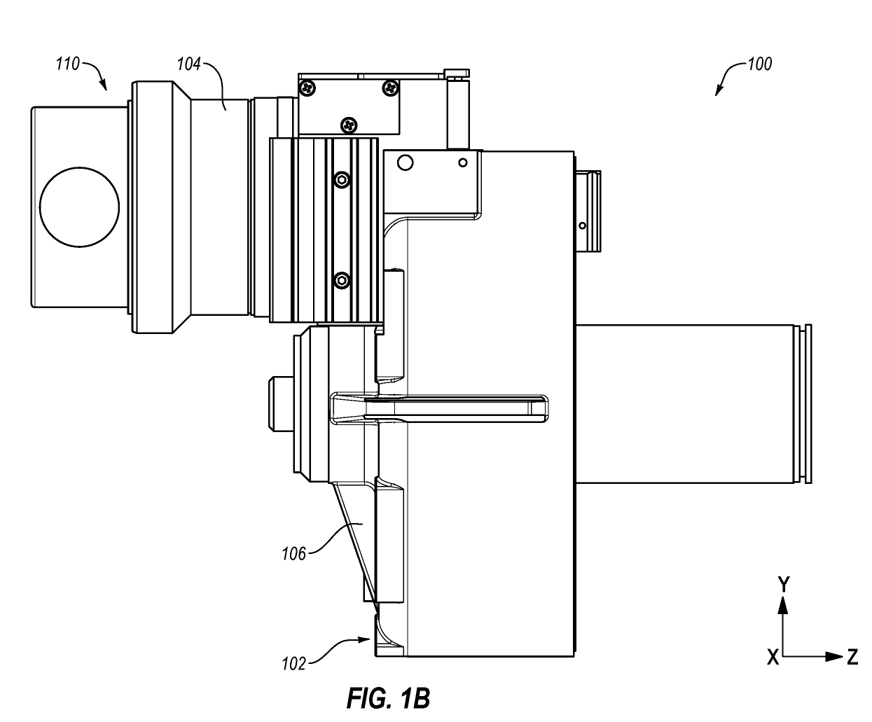

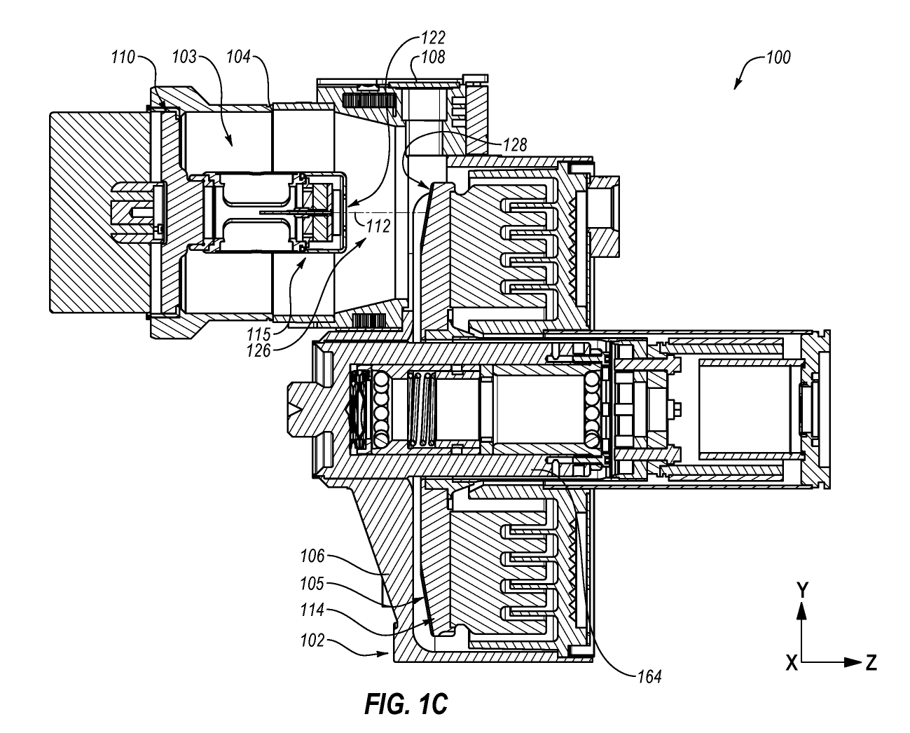

FIGS. 1A-1C are views of one example of an X-ray tube 100 in which one or more embodiments described herein may be implemented. Specifically, FIG. 1A depicts a perspective view of the X-ray tube 100 and FIG. 1B depicts a side view of the X-ray tube 100, while FIG. 1C depicts a cross-sectional view of the X-ray tube 100. The X-ray tube 100 illustrated in FIGS. 1A-1C represents an example operating environment and does not limit the embodiments disclosed herein.

Generally, X-rays are generated within the X-ray tube 100, some of which then exit the X-ray tube 100 to be utilized in one or more applications. The X-ray tube 100 may include a vacuum enclosure structure 102 which may act as the outer structure of the X-ray tube 100. The vacuum enclosure structure 102 may include a cathode housing 104 and an anode housing 106. As illustrated in FIG. 1C, the cathode housing 104 may be secured to the anode housing 106 such that an interior cathode volume 103 is defined by the cathode housing 104 and an interior anode volume 105 is defined by the anode housing 106, each of which are joined so as to define the vacuum enclosure 102.

As shown in FIGS. 1A and 1C, the X-ray tube 100 may include an X-ray transmissive window 108. Some of the X-rays that are generated in the X-ray tube 100 may exit through the window 108. The window 108 may be composed of beryllium or another suitable X-ray transmissive material.

With reference to FIG. 1C, the cathode housing 104 forms a portion of the X-ray tube referred to as a cathode assembly 110. The cathode assembly 110 generally includes components that relate to the generation of electrons that together form an electron beam, 112. For example, the cathode assembly 110 may include a cathode head 115 having an electron emitter system 122, disposed at an end of the cathode head 115.

Positioned within the anode interior volume 105 defined by the anode housing 106 is an anode 114. The anode 114 is spaced apart from and opposite to the cathode assembly 110. When an electrical current is applied to the electron emitter system 122, the electron emitter system 122 is configured to emit electrons via thermionic emission, that together form the electron beam 112 that accelerates towards a target 128 of the anode 114 in the presence of a voltage differential.

The electrons emitted by the electron emitter system 122 form an electron beam 112 and enter and traverse through an acceleration region 126 and accelerate towards the anode 114. More specifically, according to the arbitrarily-defined coordinate system included in FIGS. 1A-1C, the electron beam 112 may accelerate in a z-direction, away from the electron emitter system 122 in a direction through the acceleration region 126.

In the illustrated configuration, the anode 114 is a rotating anode configured to rotate via a rotatably mounted shaft coupled to a bearing assembly 164 or other suitable structure. As the electron beam 112 is emitted from the electron emitter system 122, electrons impinge upon the target 128 of the anode 114. In this embodiment, the target 128 is shaped as an annular ring positioned on the rotating anode 114. The region in which a large concentration of electrons of the electron beam 112 impinges on the target surface 128 is known as a focal spot. The target surface 128 may be composed of tungsten or a similar material having a high atomic (“high Z”) number. A material with a high atomic number may be used for the target 128 so that the material will correspondingly include electrons in “high” electron shells that may interact with the impinging electrons to generate X-rays. Although in this embodiment the anode 114 is a rotating anode, the concepts described herein may be applied in other anode configurations, such as a stationary anode.

During operation of the X-ray tube 100, the anode 114 and the electron emitter system 122 are connected in an electrical circuit. The electrical circuit allows the application of a high voltage potential (or voltage differential) between the anode 114 and the electron emitter system 122. Additionally, the electron emitter system 122 is connected to a power source that directs electrical current to filaments or emitters of the electron emitter system 122 to cause electrons to be generated by thermionic emission. The application of a high voltage differential between the anode 114 and the electron emitter system 122 causes the emitted electrons to form an electron beam 112 that accelerates through the acceleration region 126 towards the target 128. As the electrons within the electron beam 112 accelerate, the electron beam 112 gains kinetic energy. Upon striking the target 128, some of this kinetic energy is converted into X-rays. The target 128 is oriented such that the X-rays may pass through the window 108 and exit the X-ray tube 100 via the window 108.

In some embodiments, the vacuum enclosure 102 may be disposed within an outer housing (not shown) within which a coolant, such as liquid or air, is circulated so as to dissipate heat from the external surfaces of the vacuum enclosure 102. An external heat exchanger (not shown) may be operatively connected so as to remove heat from the coolant and recirculate it within the outer housing. In some configurations, the cathode housing 104, the anode housing 106 or components of the X-ray tube 100 may include coolant passageways.

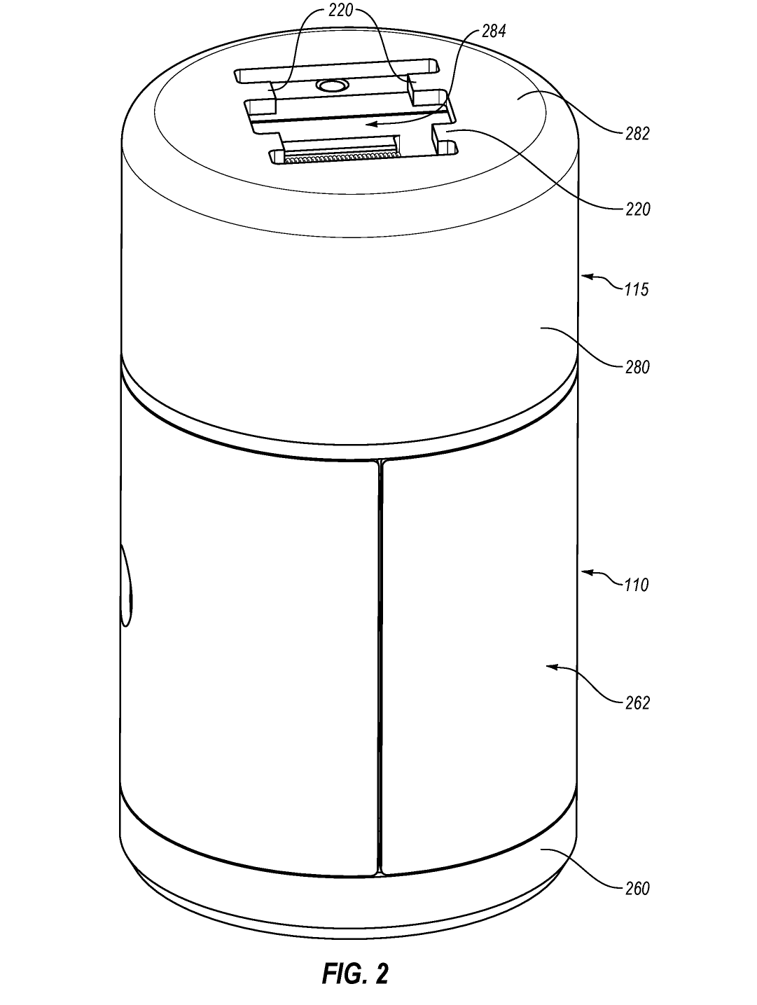

In some embodiments, the X-ray tube 100 may include one or more electron beam manipulation components. Such components can be implemented to “focus,” “steer” and/or “deflect” the electron beam 112 before it traverses the region 126, thereby manipulating or “toggling” the dimension and/or the position of the focal spot on the target surface 128. Additionally or alternatively, a manipulation component or system can be used to alter or “focus” the cross-sectional shape (e.g., length and/or width) of the electron beam and thereby change the shape and dimension of the focal spot on the target 128. In some configurations, the components configured to “focus,” “steer” and/or “deflect” the electron beam may be located on the cathode head 115 and/or the cathode assembly 110. In the embodiment illustrated in FIGS. 1A-1C, electron beam focusing and steering are provided by way of focusing tabs 220, as shown in FIG. 2.

FIG. 2 is a perspective view of an embodiment of the cathode assembly 110. With reference to FIG. 2, aspects of the cathode assembly 110 will be described in further detail. As illustrated, the cathode assembly 110 includes a bottom portion 260, a middle portion 262, and a top portion 280. The top portion 280 includes a surface 282 with an aperture 284 formed therein. The top portion 280 defines an internal cavity with the cathode head 115 positioned therein. In such configurations, the top portion 280 may be referred to as a cathode shield. The electron emitter system 122 of the cathode head 115 is positioned and oriented to emit electrons through the shield aperture 284 in a beam 112 towards the anode 114 (see FIG. 1C).

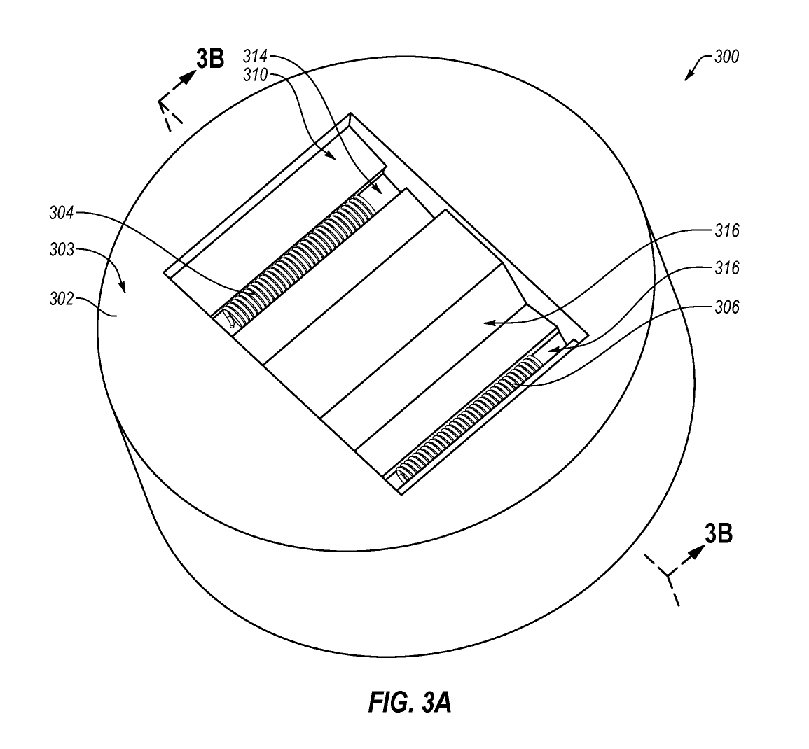

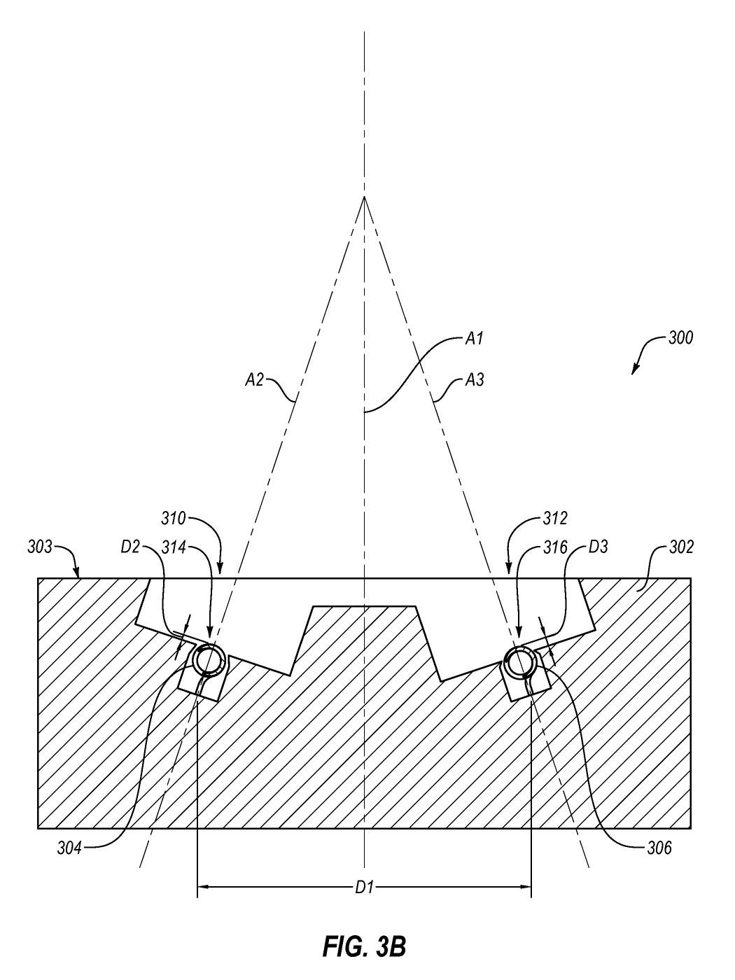

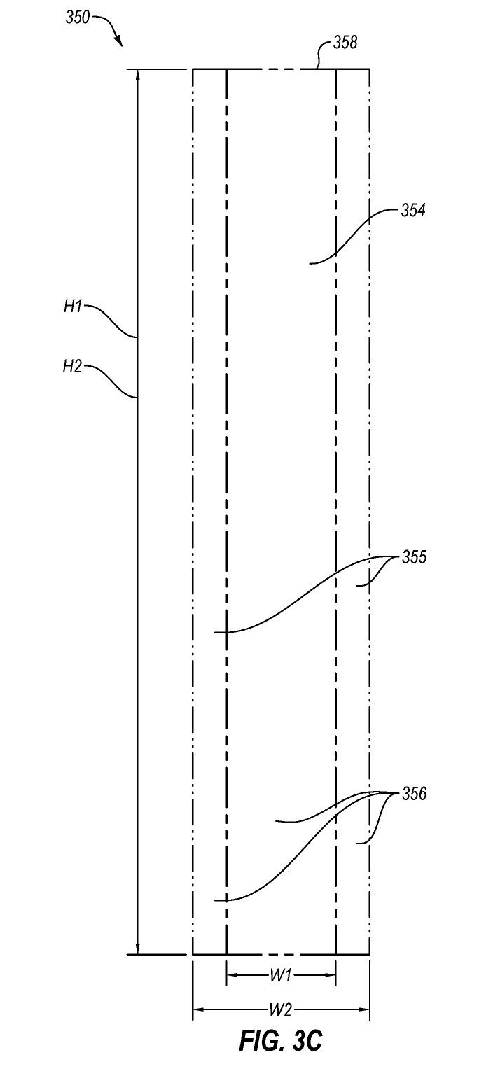

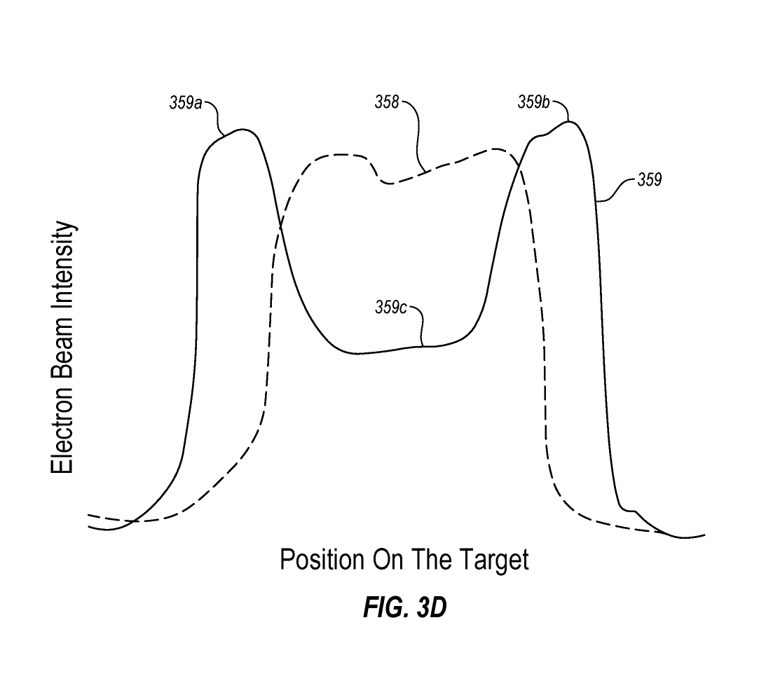

As mentioned, the focusing tabs 220 may provide beam focusing and/or steering. The focusing tabs 220 may be positioned on the top portion 280 on the surface 282 extending into the aperture 284. In some embodiments, a pair of the focusing tabs 220 may be included for each corresponding filament or emitter of the cathode head 115. Each pair of the focusing tabs 220 may be configured to impose spatial limitations on the corresponding electron beam so as to focus the electron beam by providing a desired focal spot shape and size. Additionally or alternatively, each pair of the focusing tabs 220 may be configured to steer a corresponding electron beam by positioning the focal spot on an anode target. In other configurations, the focusing tabs 220 may not be included as part of the cathode assembly 110 and focusing and/or steering structure may be provided on the cathode head itself. Such configurations are illustrated in FIGS. 3A-3D, 4A-4B, 5A-5C, 6A-6C, and are described below.

FIGS. 3A-3B illustrate an example embodiment of a cathode head 300. FIG. 3A is a perspective view the cathode head 300 and FIG. 3B is a cross-section view of the cathode head 300. The cathode head 300 may be implemented in the X-ray tube 100 of FIGS. 1A-1C and 2. Additionally or alternatively, any suitable aspects described with respect to the cathode head 300 may be included in the other embodiments described herein.

As illustrated, the cathode head 300 includes a cathode body 302, a first filament 304 and a second filament 306 (throughout this disclosure, “filaments” may also be referred to as “electron emitters”). In the illustrated configuration, the filaments 304 and 306 are coil filaments formed of a wire arranged in a spiral or helical configuration. The filaments 304 and 306 are substantially the same size and are spaced apart from one another. In other configurations, the filaments 304 and 306 may be different sizes.

The cathode body 302 defines a first filament recessed portion, implemented here as filament slot 314, and a second filament recessed portion, shown as filament slot 316. The filament 304 is positioned at least partially inside the filament slot 314 and the second filament 306 is positioned at least partially inside the filament slot 316. The cathode body 302 also defines a first focusing recessed portion, denoted as focusing slot 310 and a second focusing recessed portion, shown in the example as focusing slot 312. In the illustrated embodiment, the filament 304 and the filament slot 314 are positioned inside of the focusing slot 310, and the filament 306 and the filament slot 316 are positioned inside of the focusing slot 312. The first focusing slot 310 may be sized and shaped to focus an electron beam produced by the filament 304 and the second focusing slot 312 may be sized and shaped to focus an electron beam produced by the filament 306. Additionally or alternatively, the first focusing slot 310 may be sized and shaped to direct an electron beam produced by the filament 304 to the target, and the second focusing slot 312 may be sized and shaped to direct an electron beam produced by the filament 306 to the target.

As shown in FIG. 3B, the cathode body 302 may generally define a longitudinal axis A1. In the illustrated configuration, the longitudinal axis A1 is perpendicular to a planar cathode face 303 defined by the cathode body 302, although other configurations may be implemented. The focusing slots 310, 312 extend through the cathode face 303. The filament 304, the filament slot 314, and/or the focusing slot 310 may be oriented around a longitudinal axis A2. Similarly, the filament 306, the filament slot 316, and/or the focusing slot 312 may be oriented around a longitudinal axis A3. In the illustrated configuration the filament 304, the filament slot 314, and the focusing slot 310 are aligned with respect to one another such that they each share a common axis, the longitudinal axis A2. Furthermore, the filament 306, the filament slot 316, and the focusing slot 312 are aligned with respect to one another such that they each share a common axis, the longitudinal axis A3. However, in other configurations, the filament 304, the filament slot 314, the focusing slot 310, the filament 306, the filament slot 316, and the focusing slot 312 may not be aligned and may be oriented in other suitable configurations.

In the configuration illustrated in FIGS. 3A-3B, the filaments 304 and 306 are configured to operate simultaneously and to simultaneously direct electrons to a target on an anode (see, for example, FIG. 1C). The filaments 304, 306, the filament slots 314, 316, and the focusing slots 310, 312 are oriented toward a common target. Specifically, the focusing slot 310 may be angled with respect to the focusing slot 312 toward a common target such that an electron beam from the filament 304 and an electron beam from the filament 306 intersect generally at the common target. Similarly, the filament slot 314 may be angled with respect to the filament slot 316 such that an electron beam from the filament 304 and an electron beam from the filament 306 are directed to a common target.

With reference to FIG. 3B, in some configurations the common target may be positioned substantially at or proximate the intersection of the axis A2 and the axis A3. Accordingly, the axis A2 may be transverse to the axis A3. The axis A2 may be transverse to the axis A1 and/or the axis A3 may be transverse to the axis A1. In the illustrated representation, axis A2 and axis A3 are shown to intersect with one another and axis A1 at a single point. Accordingly, the axis A2 may be transverse to the axis A3. However, in reality the axes may not actually align as shown because of manufacturing tolerances for the cathode head 300 and its components. In addition, in other configurations the axis A2 and A3 may be oriented to intersect at a point offset from the axes A1.

The filament 304 is spaced apart from the filament 306, as denoted by distance D1. The distance D1 and the angle of axes A2 and A3 may be selected such that the filaments 304 and 306 generate streams of electrons toward a desired focal spot on a target of an anode. For example, the distance D1 and the angle of axes A2 and A3 may be selected based on the distance of the focal spot from the filaments 304, 306.

As mentioned above, the filament 304 is positioned at least partially inside the filament slot 314 and the second filament 306 is positioned at least partially inside the filament slot 316. As shown in FIG. 3B, the filament 304 may extend a distance D2 out of filament slot 314 and the filament 306 may extend a distance D3 out of the filament slot 316.

The distance the filaments 304, 306 extend out of their respective filament slots 314, 316 determines various characteristics of the electron beams produced by the filaments 304, 306. Particularly, a filament generally emits electrons from the top surface of the filament that extends out of a corresponding filament slot. When the distance that the filament extends out of the filament slot increases, the top surface of the filament that extends out of the filament slot also increases, which increases the surface area of the filament that emits electrons. Particularly, increasing the distance that the filament extends out of the filament slot increases the surface area of the filament that is exposed to a high-gradient potential gap (e.g., between the cathode and the anode), which consequently increases the number of electrons that are available to participate in thermionic emission, and thus increases the emission current.

Additionally or alternatively, increasing the distance a filament extends out of a corresponding filament slot increases the cross-section of the electron beam that is produced by the filament, which in turn may increase the size of the focal spot on the target of the anode. Particularly, increasing the surface area of the filament that emits electrons results in a wider or more spread out electron beam (e.g., at least one dimension of the cross-section is greater). A wider electron beam generally produces a larger focal spot on the target of the anode.

As illustrated in FIG. 3B, the filament 306 extends further out of the filament slot 316 than the filament 304 extends out of the filament slot 314. As such, the distance D3 is greater than the distance D2. In such configurations, the surface area that emits electrons on the filament 306 is greater than the surface area that emits electrons on the filament 304, even though the size of the filaments 304, 306 are substantially the same. Accordingly, the filament 306 produces an electron beam that has a larger cross-section than a cross-section of the electron beam produced by the filament 304. Specifically, the electron beam produced by the filament 306 is wider or more spread out than the electron beam produced by the filament. In turn, the focal spot produced on the target by the filament 306 may be larger than the focal spot produced by the filament 304.

Although a difference between distances D3 and D2 may be beneficial for increasing the overall electrons emitted by the cathode head 300, reducing the distance D2 of the filament 304 extending out of filament slot 314 (or positioning the filament 304 further in the filament slot 314) may reduce the electrons emitted from the filament 304 or reduce the size (e.g., width) of the focal spot on the target, which may negatively impact image quality in some circumstances. Accordingly, the distances D3 and D2 (and thus the difference between D3 and D2) may be selected avoid an undesired reduction in the emitted electrons and/or the size of the focal spot on the target. In such configurations, the difference between distances D3 and D2 can be small relative to other dimensions of the cathode head 300. In an example, the difference between distances D3 and D2 may be greater than manufacturing tolerances of the cathode head 300. In another example, the difference between distances D3 and D2 may be between 5 microns (μm) and 25 μm.

A power source may be electrically coupled to the filament 304 and the filament 306. The power source may simultaneously direct electrical current to the filaments 304, 306 such that the filaments 304, 306 simultaneously produce electrons that are directed to the focal spot or the target on the anode. In some configurations, the power source may be configured to operate the filaments 304, 306 at substantially the same current and/or voltage levels, although other configurations may be implemented. The filaments 304, 306 may be connected to the power source either in series or in parallel, depending on the desired configuration.

FIG. 3C is a schematic representation of a focal spot created by the cathode head 300. As mentioned, the filament 304 and the filament 306 are oriented toward a common target 350. An electron beam from the filament 304 impinges the target 350 at a first focal spot 354 and an electron beam from the filament 306 impinges the target 350 at a second focal spot 356. As illustrated, the focal spot 356 extends past the focal spot 354. As such, the focal spot 354 is positioned entirely within the focal spot 356 or substantially within the focal spot 356. The focal spot 354 and the focal spot 356 form a combined focal spot 358.

As mentioned, the electron beam produced by the filament 306 has a larger cross-section than a cross-section of the electron beam produced by the filament 304 because the filament 306 is positioned further out of the filament slot 316 than the filament 304 is positioned out of the filament slot 314. In particular, the electron beam produced by the filament 306 has at least one cross-sectional dimension greater than a corresponding cross-sectional dimension of the electron beam produced by the filament 304. This is despite the filaments 304 and 306 having substantially the same size and shape. In turn, the focal spot 356 produced by the filament 306 has at least has at least one cross-sectional dimension greater than a corresponding cross-sectional dimension of the focal spot 354 produced by the filament 304.

As mentioned above, positioning the filament 306 further out of the corresponding filament slot than the filament 304 may be beneficial for increasing the overall electrons emitted by the cathode head 300. However, reducing the distance the filament 304 extends out of filament slot 314 (or positioning the filament 304 further in the filament slot 314) may reduce the electrons emitted from the filament 304 or reduce the size (e.g., width) of the focal spot 354 on the target 350, and in some circumstances, this may reduce image quality, especially with respect to portions of the target 350 where the focal spot 356 does not overlap with the focal spot 354, denoted at 355. Accordingly, the distances that the filaments 304, 306 extend out of the corresponding filament slots 314, 316 may be selected to avoid an undesired reduction in the emitted electrons and/or the size of the focal spots 354, 356 on the target 350.

For example, the difference between the distance D3 and the distance D2 may be such that the focal spot 354 covers or overlaps between 70% and 99% of the area of the focal spot 356. In another example, the difference between the distance D3 and the distance D2 may be such that the focal spot 354 covers or overlaps between 80% and 99% of the area of the focal spot 356. In another example the difference between the distance D3 and the distance D2 may be such that the focal spot 354 covers or overlaps between 90% and 99% of the area of the focal spot 356.

As shown in FIG. 3C, the focal spot 354 includes a width W1 and the focal spot 356 includes a width W2. The width W2 is greater than the width W1, because the electron emission from the filament 306 spread wider than the electron emission from the filament 304. The focal spot 354 also includes a height H1 and the focal spot 356 includes a height H2. The dimensions of the heights H1 and the heights H2 may at least partially depend on the coiled length of the corresponding filaments 304 and 306. Since the coiled length of the filaments 304 and 306 are substantially equal, the height H1 and the height H2 are substantially the same. Nevertheless, other configurations may be implemented.

The combined focal spot 358 is defined by the outer dimensions of the focal spots 354 and 356. Accordingly, the combined focal spot 358 includes a width W2 and a height H2, since the focal spot 354 is positioned entirely within the focal spot 356 or substantially within the focal spot 356. As illustrated, the focal spot 354 is centered within the focal spot 356. The focal spots 354 and 356 may be concentric.

In FIG. 3C, the focal spots 354, 356 are represented with rectangles that generally denote where electrons of the respective electron beams impinge on the target 350. Nevertheless, it is understood that some electrons may stray from the electron beam and impinge at other portions of the target 350. Furthermore, in other configurations the focal spots 354, 356 may not be substantially rectangular, and may have focal spots of other shapes and size. Additionally or alternatively, the focal spots 354, 356 may represent the dimensions of the respective electron beams as they impinge on the target 350, and thus may represent a cross-section of the electron beams at the target 350.

The target 350 may be representative of the target 128 of the anode 114 of FIG. 1C. Specifically, since the anode 114 is a rotating anode and the target 128 is an annular ring, the target 350 represents the specific portion of the target 128 that receives the electron beam(s) at a given moment. Alternatively, the target 350 may represent a fixed target on a stationary anode.

As mentioned, the focal spot 354 and the focal spot 356 form a combined focal spot 358, defined by the outer dimensions of the focal spots 354 and 356. Using the configurations disclosed herein may result in a combined focal spot with a more uniform intensity when compared to a focal spots produced by a single filament. FIG. 3D is a diagram of focal spot intensity that compares the combined focal spot 358 to a focal spot 359 formed by a single filament. Specifically, the diagram illustrates the electron beam intensity with respect to position on a target in one direction.

As shown, the focal spot 359 formed by a single filament includes peaks 359a, 359b positioned towards the edge of the focal spot, and a valley 359c positioned towards the center of the focal spot. Accordingly, the focal spot 359 does not exhibit generally uniform intensity, which may result in poorer X-ray imaging resolution.

In contrast, the combined focal spot 356 exhibits more uniform electron beam intensity, without exhibiting major peaks or valley in the electron beam distribution. Uniform beam distribution may be facilitated by positioning the smaller focal spot 354 entirely within the larger focal spot 356, as will be explained with combined reference to FIGS. 3C and 3D. In particular, either or both of the focal spots 354, 356 may individually exhibit peaks and valleys, similar to those shown with respect to the focal spot 359. However, positioning the smaller focal spot 354 entirely within the larger focal spot 356 produces a more uniform intensity profile when the electron distribution is combined. For example, a valley that may be formed by the larger focal spot 356 may be at least partially filled by the electron beam from the smaller focal spot 354, based on its size (e.g., approximately the size of the valley) and/or position (e.g., substantially in the center of the larger focal spot 356). Similarly, a valley that may be formed by the smaller focal spot 354 may be at least partially mitigated by the electron beam from the larger focal spot 356. Accordingly, when combined, the focal spots 354, 356 may create the combined focal spot 358 with a more uniform electron beam intensity.

In addition, in some circumstances it may be difficult to precisely position the focal spots emitting from two filaments, for example, due to manufacturing tolerances. Accordingly, it may be difficult to position focal spots to be side-by-side or overlap one another while maintaining uniform focal spot intensity. In contrast, positioning the smaller focal spot 354 within the larger focal spot 356 may facilitate compensating for variations in focal spot size and position caused by manufacturing tolerances. Accordingly, the described embodiments facilitate forming a uniform focal spot despite manufacturing tolerances. This may also increase the reliability of the cathode head and the X-ray tube.

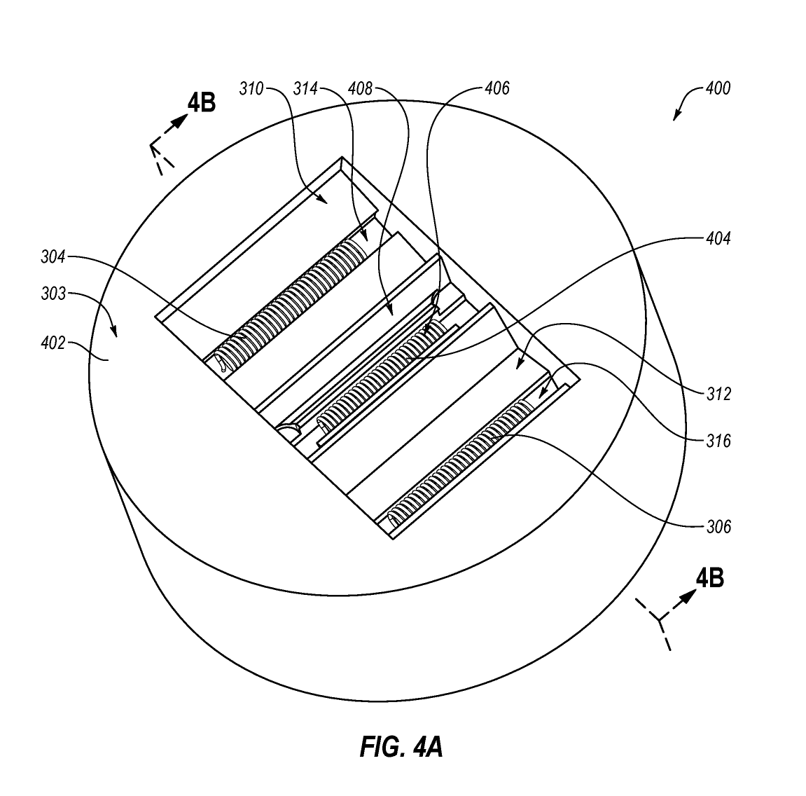

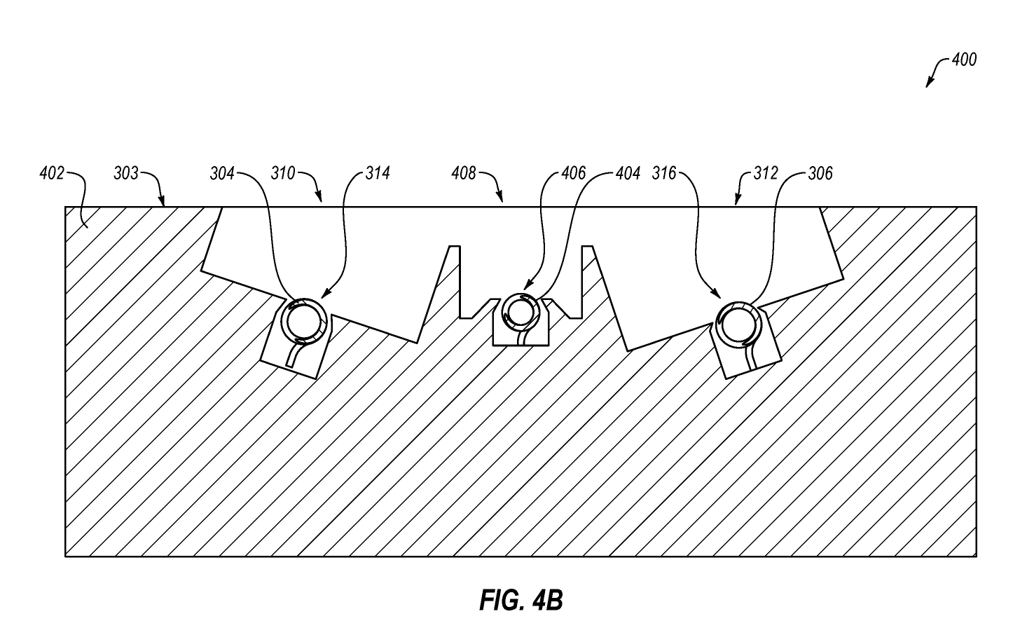

FIGS. 4A-4B illustrate another example embodiment of a cathode head 400. FIG. 4A is a perspective view the cathode head 400 and FIG. 4B is a cross-section view of the cathode head 400. The cathode head 400 includes aspects described above with respect to the cathode head 300, and such components are indicated with the same numbering described above with respect to FIG. 3A-3B. The cathode head 400 may be implemented in the X-ray tube 100 of FIGS. 1A-1C and 2. Additionally or alternatively, any suitable aspects described with respect to the cathode head 400 may be included in the other embodiments described herein.

The cathode head 400 includes the first filament 304, the second filament 306, and also a third filament 404 positioned between the first filament 304 and the second filament 306. The filament 404 is a coil filament formed of a wire arranged in a spiral or helical configuration. While the filaments 304 and 306 are substantially the same size, the filament 404 is smaller than the filaments 304, 306, although other configurations may be implemented.

The cathode head 400 includes a cathode body 402 that defines the first filament recess, denoted here as a filament slot 314, a second filament recess denoted as a filament slot 316, and a third filament recess, implemented as a filament slot 406. The filament 404 is positioned at least partially inside the filament slot 406. The cathode body 402 also defines a third focusing recess, denoted as focusing slot 408, along with the first focusing slot 310 and the second focusing slot 312. The filament 404 and the filament slot 406 are positioned inside of the focusing slot 408.

The focusing slot 408 may be sized and shaped to focus and/or direct an electron beam produced by the filament 404. The filament 404, the filament slot 406, and the focusing slot 408 may be aligned with respect to one another such that they each share a common axis. In some configurations, the common axis may be a longitudinal axis of the cathode body 402. The filament 404, the filament slot 406, and the focusing slot 408 may be oriented toward the same common focal spot as the filaments 304 and 306.

As mentioned, the filament 404 may be smaller than the filaments 304, 306. The filament 404 may include at least one dimension smaller than the filament 304 and/or the filament 306. For example, the filament 404 may include an overall length, coil length, filament diameter, coil diameter, or other dimension that is smaller than a corresponding dimension of the filament 304 and/or the filament 306. Additionally or alternatively, the filament 404 may operate at different current and/or voltage levels that the filaments 304, 306. Thus, the focal spot produced by the filament 404 may be a different size (e.g., one or more dimensions smaller) than the focal spots produced by the filaments 304, 306, or the combined focal spot produced by both of the filaments 304, 306.

As described above, the filaments 304 and 306 are configured to operate simultaneously and to simultaneously direct electrons to a target on an anode (see, for example, FIG. 1C). In contrast, the filament 404 may be configured to operate independently of the filaments 304 and 306. As such, the filament 404 may be configured to activate when the filaments 304 and 306 are deactivated, or vice versa. Notwithstanding, the filament 404, the filament slot 406, and the focusing slot 408 may be configured to form a focal spot on a target in a same or similar area as the focal spots formed by the filaments 304 and 306. Accordingly, the filaments 304, 306, 404 the filament slots 314, 316, 406 and the focusing slots 310, 312, 408 are oriented toward a common target. Specifically, the focusing slots 310, 312 may be angled toward a common target such that electron beams from filaments 304, 306, and 404 are generally directed at the common target.

A power source may be electrically coupled to the filament 304, the filament 306, and the filament 404. The power source may simultaneously direct electrical current to the filaments 304, 306 such that the filaments 304, 306 simultaneously produce electrons that are directed to the focal spot or the target on the anode. The power source may direct electrical current to the filament 404 independently of the filaments 304, 306. Such that the filament 404 produces electrons when the filaments 304, 306 are not activated, and vice versa. In some configurations, the power source may be configured to operate the filaments 304, 306 at different current and/or voltage level than the filament 404.

In other configurations, all three of the filaments 304, 306, and 404 may operate simultaneously. In such configurations, the power source may simultaneously direct electrical current to the filaments 304, 306, 404 such that the filaments 304, 306, 404 simultaneously produce electrons that are directed to the focal spot or the target on the anode. In such configurations, all three of the filaments 304, 306, 404 may substantially be the same size and shape, although other configurations may be implemented. The filaments 304, 306, 404 may be connected to the power source either in series or in parallel, depending on the desired configuration.

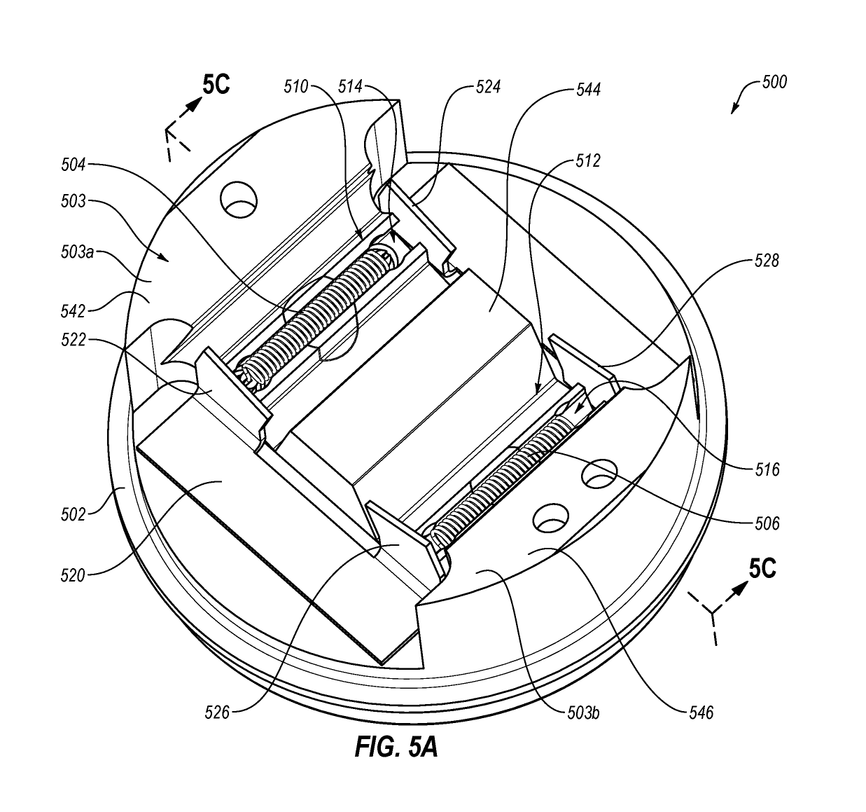

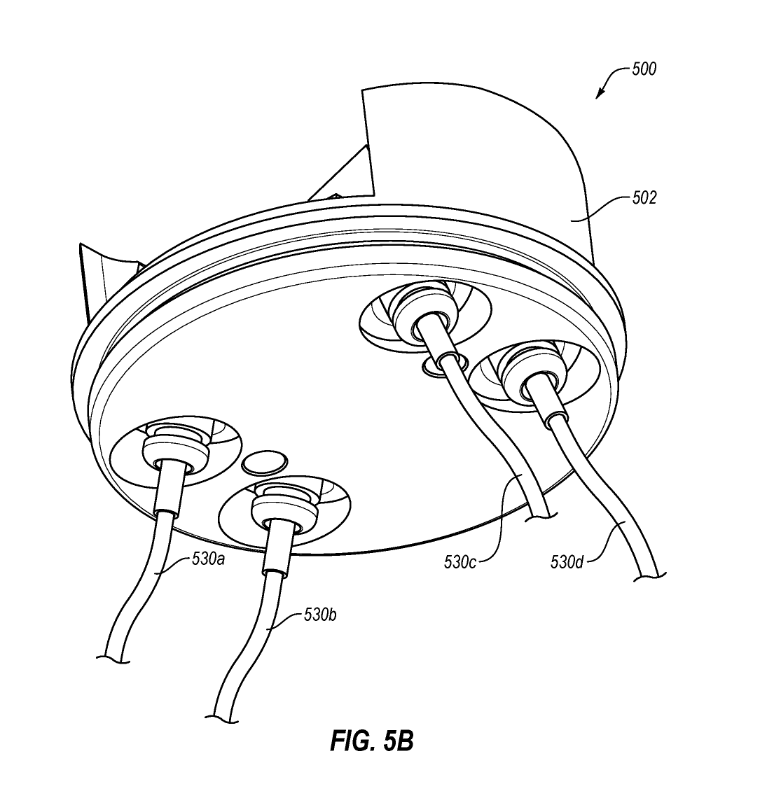

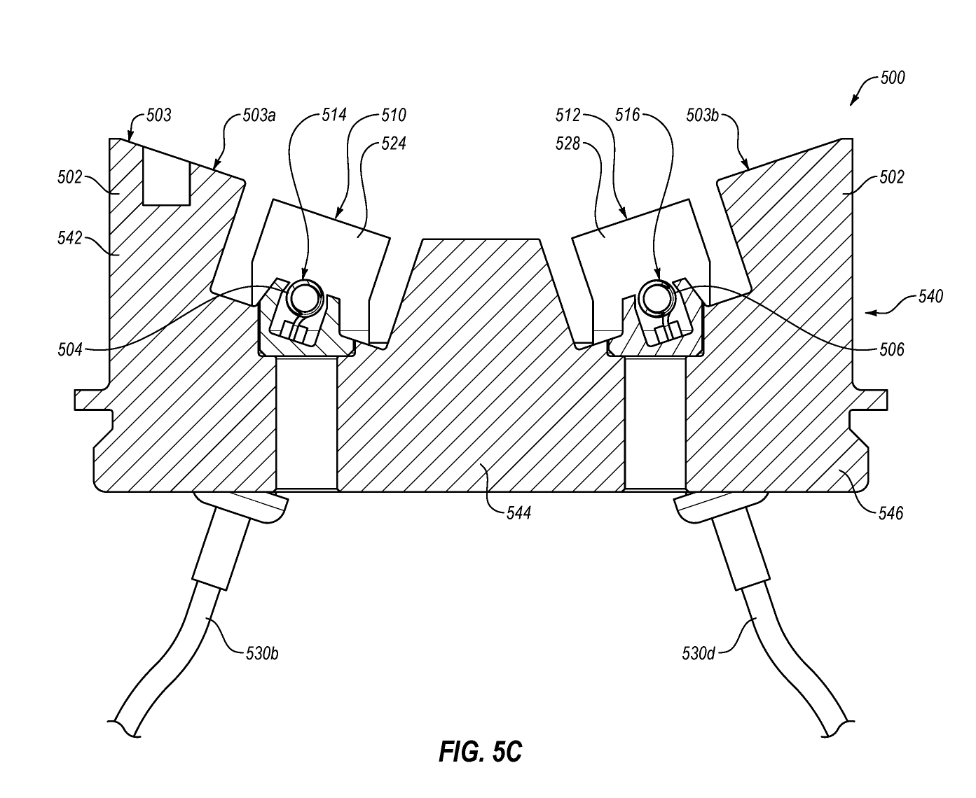

FIGS. 5A-5C illustrate another example embodiment of a cathode head 500. FIG. 5A is a top perspective view the cathode head 500, FIG. 5B is a bottom perspective view the cathode head 500, and FIG. 5C is a cross-section view of the cathode head 500. The cathode head 500 includes aspects similar to those described above with respect to the cathode heads 300 and 400, and similar numbers are used to indicate similar components. Any suitable aspects described with respect to the cathode heads 300 and 400 may apply with respect to the cathode head 500. Additionally or alternatively, any suitable aspects described with respect to the cathode head 500 may be included in the other embodiments described herein.

As illustrated, the cathode head 500 includes a cathode body 502, a first filament 504 and a second filament 506. In the illustrated configuration, the filaments 504 and 506 are coil filaments formed of a wire arranged in a spiral or helical configuration. The filaments 504 and 506 are substantially the same size and are spaced apart from one another. In other configurations, the filaments 504 and 506 may be different sizes.

The cathode body 502 defines a first filament recess, denoted at filament slot 514, and a second filament recess, denoted at filament slot 516. The filament 504 is positioned at least partially inside the filament slot 514 and the second filament 506 is positioned at least partially inside the filament slot 516. The cathode body 502 also defines a first focusing recess, denoted at focusing slot 510, and a second focusing recess, denoted at focusing slot 512. The filament 504 and the filament slot 514 are positioned inside of the focusing slot 510, and the filament 506 and the filament slot 516 are positioned inside of the focusing slot 512. The first focusing slot 510 may be sized and shaped to focus an electron beam produced by the filament 504 and the second focusing slot 512 may be sized and shaped to focus an electron beam produced by the filament 506. Additionally or alternatively, the first focusing slot 510 may be sized and shaped to direct an electron beam produced by the filament 504 to the target, and the second focusing slot 512 may be sized and shaped to direct an electron beam produced by the filament 506 to the target.

In some configurations, the filament 504, the filament slot 514, and the focusing slot 510 may be aligned with respect to one another such that they each share a common axis. Similarly, the filament 506, the filament slot 516, and the focusing slot 512 may be aligned with respect to one another such that they each share a second common axis. In other configurations, the filament 504, the filament slot 514, the focusing slot 510, the filament 506, the filament slot 516, and the focusing slot 512 may not be aligned and may be oriented in other suitable configurations.

In the configuration illustrated in FIGS. 5A-5B, the filaments 504 and 506 are spaced apart from one another and are configured to operate simultaneously and to simultaneously direct electrons to a target on an anode (see, for example, FIG. 1C). The filaments 504, 506, the filament slots 514, 516, and the focusing slots 510, 512 are oriented toward a common target. Specifically, the focusing slot 510 may be angled with respect to the focusing slot 512 toward a common target such that an electron beam from the filament 504 and an electron beam from the filament 506 intersect generally at the common target. Similarly, the filament slot 514 may be angled with respect to the filament slot 516 such that an electron beam from the filament 504 and an electron beam from the filament 506 are directed to a common target. Additional details regarding orientation toward a common target are described above (see description of FIGS. 3A-3B).

As mentioned above, the filament 504 is positioned at least partially inside the filament slot 514 and the second filament 506 is positioned at least partially inside the filament slot 516. As illustrated in FIG. 5C, the filament 506 extends further out of the filament slot 516 than the filament 504 extends out of the filament slot 514. In such configurations, the surface area that emits electrons on the filament 506 is greater than the surface area that emits electrons on the filament 504, even though the size of the filaments 504, 506 are substantially the same. Accordingly, the filament 506 produces an electron beam that has a larger cross-section than a cross-section of the electron beam produced by the filament 504. Specifically, the electron beam produced by the filament 506 is wider or more spread out than the electron beam produced by the filament. In turn, the focal spot produced on the target by the filament 506 may be larger than the focal spot produced by the filament 504. Additional details regarding the positioning of filaments with respect to filament slots are described above (see description of FIGS. 3A-3B).

The cathode body 502 defines a cathode face 503. In contrast to the planar cathode face 303 shown in FIGS. 3A-3B, the cathode face 503 does not extend along a single plane. Instead, the cathode face 503 includes a first angled portion 503a and a second angled portion 503b. The angled portion 503a may extend transverse or substantially perpendicular to the longitudinal axis extending through the filament 504, the filament slot 514, and the focusing slot 510. The angled portion 503b may extend transverse or substantially perpendicular to the longitudinal axis extending through the filament 506, the filament slot 516, and the focusing slot 512.

In some configurations, the cathode head 500 may include a focusing and/or steering structure (generally referred to as a “focusing structure”). The “focusing” may provide a desired focal spot shape and size, and the “steering” may change the positioning of the focal spot on the anode target. The focusing structure may at least partially surround the filaments 504, 506 and may focus and/or steer the electron beams emitted by the filaments 504, 506 by imposing electrical fields and/or spatial limitations on the electron beams.

In the illustrated configuration, the focusing structure includes a focusing grid 540 that includes a first grid member 542, a second grid member 544, and a third grid member 546. The combination of the first grid member 542 and the second grid member 544 forms a first focusing grid pair, and the combination of the second grid member 544 and the third grid member 546 forms a second focusing grid pair. As best illustrated in FIG. 5C, the first grid member 542 and second grid member 544 includes the filament 504 positioned therebetween and the third grid member 546 and the second grid member 544 includes the filament 506 positioned therebetween. The focusing grid 540 may be configured to receive a grid voltage to focus electrons emitted by the filaments 504, 506. Particularly, the focusing grid 540 may focus the electron beam in one direction perpendicular to the beam path, and/or steer the beam in that same direction perpendicular to the beam path. The voltages of the grid members 542, 544, 546 can be modulated so as to provide a beam with a given dimension. Specifically, the voltage difference between the two grid members for each coil filament may be modulated to change one or more cross-sectional dimension of the electron beam.

Additionally or alternatively, the focusing structure may include a second focusing grid 520. The focusing grid 520 may include focusing tab pairs corresponding to each of the filaments 504, 506. The filament 504 may be positioned between a first tab pair formed of a first tab 522 and a second tab 524. The filament 506 may be positioned between a first tab pair formed of a third tab 526 and a fourth tab 526. The focusing grid 520 may be configured to receive a grid voltage to focus electrons emitted by the filaments 504, 506. The focusing tabs 522, 524, 526, and 528 may form focusing grid pairs and may receive a voltage difference to focus and/or steer the electron beam in a direction orthogonal to the focusing grid 540. The voltages of the focusing tabs 522, 524, 526, and 528 can be modulated so as to provide a beam with a given dimension. Specifically, the voltage difference between the two tabs for each coil filament may be modulated to change one or more cross-sectional dimension of the electron beam. In other configurations, the focusing tabs 522, 524, 526, and 528 may impose spatial limitations on corresponding electron beams rather than providing focusing and/or steering electrostatically.

In some circumstances, the focusing grid 520 and/or the focusing grid 540 may be used to “cut off” the electron beam by providing a sufficiently large voltage to prevent the electron beam from reaching the target and/or the focal spot. “Cutting off” the electron beam(s) may be used for controlling the amount of total X-rays received by a patient or object during an X-ray scan. For example, cutting off the electron beam(s) may be used to limit the amount of X-rays a patient or object receives during a scan. This may be useful, for example, during cardiac scanning of a patient. Accordingly, the focusing grid 520 and/or the focusing grid 540 may be used to control the emission of X-rays from the X-ray tube by cutting off electron beams from the filaments 504, 506. The focusing grid 520 and/or the focusing grid 540 may be used to focus, direct, and/or cut off the electron beam of both filaments 504, 506. Advantageously, the same focusing structure may be used to focus, direct, and/or cut off the electron beam of both filaments 504, 506.

In configurations where two filaments are operated simultaneously, it may be easier to implement and use focusing structure to focus and/or steer the electron beams. Particularly, each filament may require less current and/or voltage to create a focal spot with greater electron intensity, because electrons from both of the filaments are aggregated. Since the filaments are operating at lower current and voltage levels, less voltage may be required in a focusing grid to sufficiently focus and/or steer the electron beams. Similarly, a lower voltage may be required to “cut off” the electron beam. In contrast, in configurations where a larger filament is used, or greater current or voltage is applied to the filament, a larger grid voltage may be required to focus and/or steer the electron beams. In addition, when two similar or identical filaments are operated simultaneously, a single grid voltage may be used to focus and/or steer both of the electron beams. In contrast, filaments of different sizes may use separate grid voltages for each. In some circumstances, using multiple emitters at the same time allows for grid components (e.g., gridded surfaces) to be suitably close enough to the emitters to influence the produced electron beam in a desired manner.

The embodiments described herein may be implemented with any suitable focusing structure, such as a spatial, magnetic, electrostatic, or combination thereof. The described embodiments may be implemented using a single electrostatic focusing grid or multiple grid configurations (e.g., dual grids). In other configurations, embodiments may not include electrostatic focusing and may rely on other suitable focusing structures, such as spatial and/or magnetic. Although in the illustrated configuration the focusing structure includes two focusing grids, in other configurations only one may be included. Additionally or alternatively, any suitable focusing structures, such as the ones described herein, may be implemented in the cathode heads 300 and 400.

As best shown in FIG. 5B, the cathode head 500 may include electrical couplings 530a, 530b, 530c, and 530d. A power source may be electrically coupled to the filament 504 and the filament 506 via the electrical couplings 530a-d. Particularly, the electrical couplings 530a-d may extend through the cathode body 502 to couple the filaments 504, 506. Each of the filaments 504, 506 may include a corresponding pair of electrical couplings. For example, electrical couplings 530a and 530b may correspond to filament 504 and electrical couplings 530c and 530d may correspond to filament 506. Although not illustrated, electrical couplings may be provided to electrically couple the focusing structure. Furthermore, although electrical couplings are not shown with respect to the cathode heads 400 and 500, it should be understood that the cathode heads 400 and 500 also generally include suitable electrical couplings.

The power source may simultaneously direct electrical current to the filaments 504, 506 such that the filaments 504, 506 simultaneously produce electrons that are directed to the focal spot or the target on the anode. In some configurations, the power source may be configured to operate the filaments 504, 506 at substantially the same current and/or voltage levels, although other configurations may be implemented. The filaments 504, 506 may be connected to the power source either in series or in parallel, depending on the desired configuration.

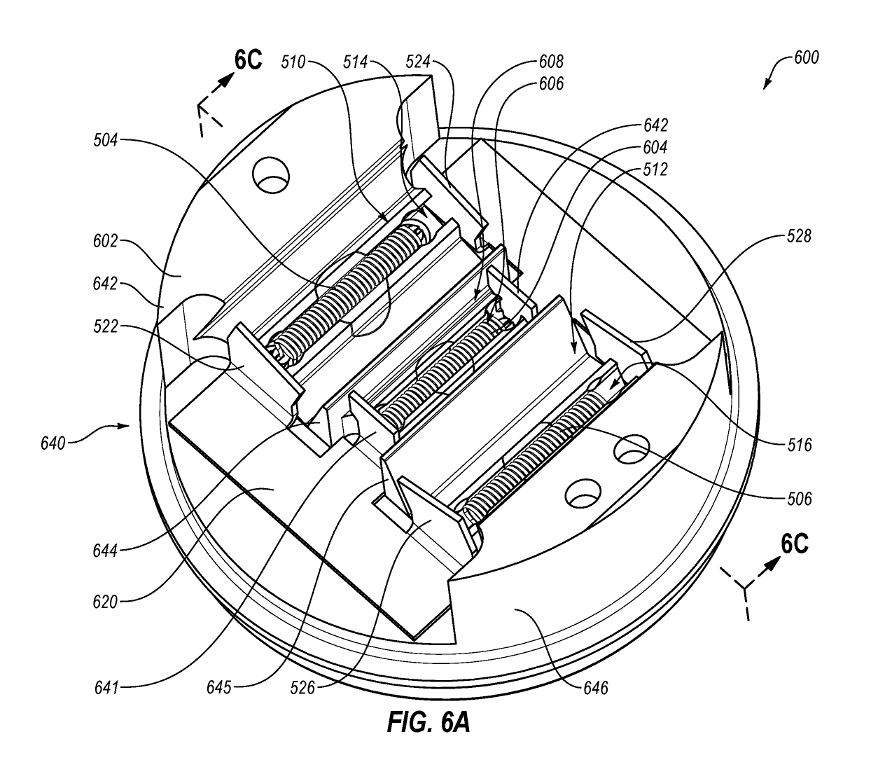

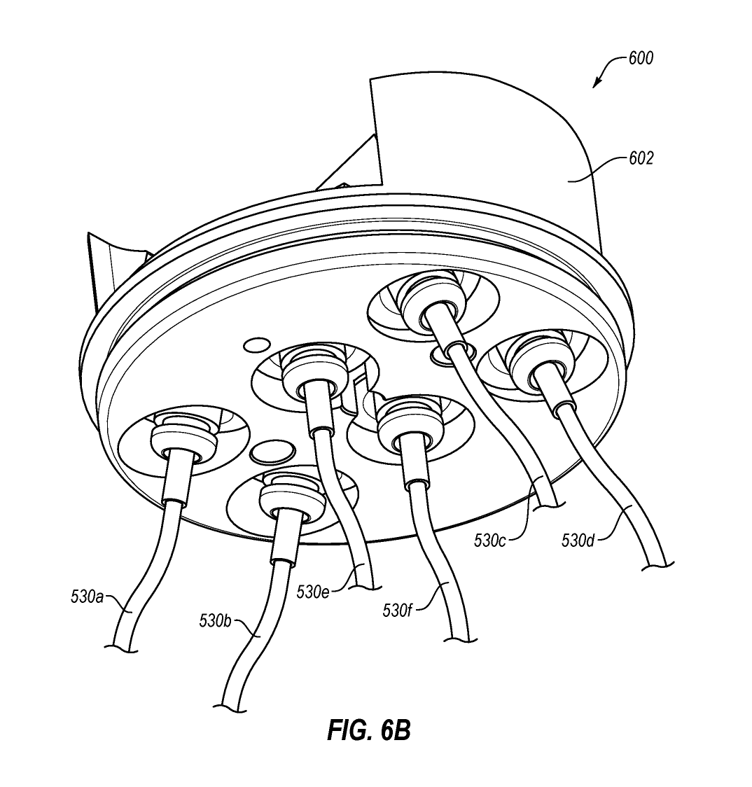

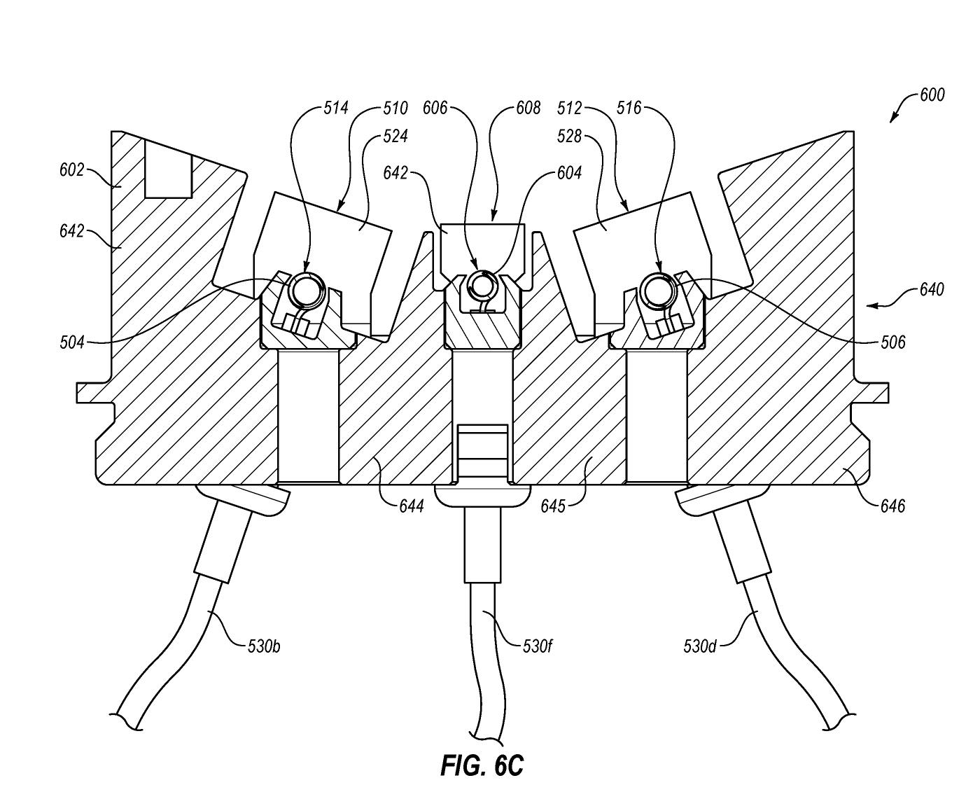

FIGS. 6A-6C illustrate another example embodiment of a cathode head 600. FIG. 6A is a top perspective view the cathode head 600, FIG. 6B is a bottom perspective view the cathode head 600, and FIG. 6C is a cross-section view of the cathode head 600. The cathode head 600 includes aspects described above with respect to the cathode head 500, and such components are indicated with the same numbering described above with respect to FIG. 5A-5C. The cathode head 600 may be implemented in the X-ray tube 100 of FIGS. 1A-1C and 2. Additionally or alternatively, any suitable aspects described with respect to the cathode head 600 may be included in the other embodiments described herein.

The cathode head 600 includes the first filament 504, the second filament 506, and also a third filament 604 positioned between the first filament 504 and the second filament 506. The filament 604 is a coil filament formed of a wire arranged in a spiral or helical configuration. While the filaments 504 and 506 are substantially the same size, the filament 604 is smaller than the filaments 504, 506, although other configurations may be implemented.

The cathode head 600 includes a cathode body 602 that defines the first filament recess, denoted at filament slot 514, the second filament recess, denoted at filament slot 516, and a third filament recess, denoted at filament slot 606. The filament 604 is positioned at least partially inside the filament slot 606. The cathode body 602 also defines a third focusing recess, denoted at focusing slot 608, along with the first focusing recess and the second focusing recess (denoted as focusing slots 510 and 512). The filament 604 and the filament slot 606 are positioned inside of the focusing slot 608.

The focusing slot 608 may be sized and shaped to focus and/or direct an electron beam produced by the filament 604. The filament 604, the filament slot 606, and the focusing slot 608 may be aligned with respect to one another such that they each share a common axis. In some configurations, the common axis may be a longitudinal axis of the cathode body 602. The filament 604, the filament slot 606, and the focusing slot 608 may be oriented toward the same common focal spot as the filaments 504 and 506.

As mentioned, the filament 604 may be smaller than the filaments 504, 506. The filament 604 may include at least one dimension smaller than the filament 504 and/or the filament 506. For example, the filament 604 may include an overall length, coil length, filament diameter, coil diameter, or other dimension that is smaller than a corresponding dimension of the filament 504 and/or the filament 506. Additionally or alternatively, the filament 604 may operate at different current and/or voltage levels that the filaments 504, 506. Thus, the focal spot produced by the filament 604 may be a different size (e.g., one or more dimensions smaller) than the focal spots produced by the filaments 504, 506, or the combined focal spot produced by both of the filaments 504, 506.

As described above, the filaments 504 and 506 are configured to operate simultaneously and to simultaneously direct electrons to a target on an anode (see, for example, FIG. 1C). In contrast, the filament 604 may be configured to operate independently of the filaments 504 and 506. As such, the filament 604 may be configured to activate when the filaments 504 and 506 are deactivated, or vice versa. Notwithstanding, the filament 604, the filament slot 506, and the focusing slot 508 may be configured to form a focal spot on a target in a same or similar area as the focal spots formed by the filaments 504 and 506. Accordingly, the filaments 504, 506, 604 the filament slots 514, 516, 606 and the focusing slots 510, 512, 608 are oriented toward a common target. Specifically, the focusing slots 510, 512 may be angled toward a common target such that electron beams from filaments 504, 506, and 604 are generally directed at the common target.

The cathode head 600 may include a focusing structure. The focusing structure may at least partially surround the filaments 504, 506, 604 and may focus and/or steer the electron beams emitted by the filaments 504, 506, 604 by imposing electrical fields and/or spatial limitations on the electron beams.

In the illustrated configuration, the focusing structure includes a focusing grid 640 that includes the first grid member 642, a second grid member 644, a third grid member 645, and a fourth grid member 646. The combination of the first grid member 642 and the second grid member 644 forms a first focusing grid pair, the combination of the second grid member 644 and third grid member 645 forms a second focusing grid pair, and the combination of the second grid member 645 and third grid member 646 forms a third focusing grid pair.

As best illustrated in FIG. 6C, the first grid member 642 and the second grid member 644 includes the filament 504 positioned therebetween, the second grid member 644 and the third grid member includes the filament 604 positioned therebetween, and the third grid member 645 and fourth grid member 646 includes the filament 506 positioned therebetween. The focusing grid 640 may be configured to receive a grid voltage to focus electrons emitted by the filaments 504, 506, 604. Particularly, the focusing grid 640 may focus the electron beam in one direction perpendicular to the beam path, and/or steer the beam in that same direction perpendicular to the beam path. The voltages of the grid members 642, 644, 645, and 646 can be modulated so as to provide a beam with a given dimension. Specifically, the voltage difference between the two grid members for each coil filament may be modulated to change one or more cross-sectional dimension of the electron beam.

Additionally or alternatively, the focusing structure may include a second focusing grid 620. The focusing grid 620 may include focusing tab pairs corresponding to each of the filaments 504, 506, 604. In particular, the focusing grid 620 may include the focusing tab pairs formed of the first tab 522, the second tab 524, the third tab 526, and the fourth tab 528, as described above. In addition, the focusing grid 620 includes a third tab pair formed of a fifth tab 640 and a sixth tab 642 with the filament 604 positioned therebetween.

The focusing grid 620 may be configured to receive a grid voltage to focus electrons emitted by the filaments 504, 506, 604. The focusing tabs 522, 524, 526, 528, 640, and 642 may form focusing grid pairs and may receive a voltage difference to focus and/or steer the electron beam, as described above with respect to the focusing grid 520.

The focusing grid 620 and/or the focusing grid 640 may be used to focus, direct, and/or cut off the electron beam of all three filaments 504, 506, and 604, in a manner as described above with respect to the focusing grids 520, 540. In some configurations, one grid voltage may be used when two filaments 504, 506 are operating, and a different grid voltage may be used when one filament 604 is operating. In addition, one cutoff voltage may be used to cutoff the electron beam of the two filaments 504, 506, and a different cutoff voltage may be used to cutoff the electron beam of the one filament 604. Advantageously, the same focusing structure may be used to focus, direct, and/or cut off the electron beam of all three filaments 504, 506, and 604.

The embodiments described herein may be implemented with any suitable focusing structure, such as a magnetic, electrostatic, or combination thereof. The described embodiments may be implemented using a single electrostatic focusing grid or multiple grid configurations (e.g., dual grids). Although in the illustrated configuration the focusing structure includes two focusing grids, in other configurations only one or the other may be included. Additionally or alternatively, any suitable focusing structures, such as the ones described herein, may be implemented in the cathode heads 300, 400, and 500.

As best shown in FIG. 6B, the cathode head 500 may include electrical couplings 530e and 530f in addition to the electrical couplings 530a-d. The electrical couplings 530e-f may extend through the cathode body to couple the filament 604. A power source may be electrically coupled to the filament 504, the filament 506, and the filament 604 via the electrical couplings 530a-e. The power source may simultaneously direct electrical current to the filaments 504, 506 such that the filaments 504, 506 simultaneously produce electrons that are directed to the focal spot or the target on the anode. The power source may direct electrical current to the filament 604 independently of the filaments 504, 506, such that the filament 604 produces electrons when the filaments 504, 506 are not activated, and vice versa. In some configurations, the power source may be configured to operate the filaments 504, 506 at different current and/or voltage level than the filament 604. Although not illustrated, electrical couplings may be provided to electrically couple the focusing structure.

In other configurations, all three of the filaments 504, 506, and 604 may operate simultaneously. In such configurations, the power source may simultaneously direct electrical current to the filaments 504, 506, 604 such that the filaments 504, 506, 604 simultaneously produce electrons that are directed to the focal spot or the target on the anode. In such configurations, all three of the filaments 504, 506, 604 may substantially be the same size and shape, although other configurations may be implemented. The filaments 504, 506, 604 may be connected to the power source either in series or in parallel, depending on the desired configuration.

In one embodiment, a cathode (300, 400, 500, 600) for an X-ray tube (100) includes a first electron emitter (304, 504), a second electron emitter (306, 506), and a cathode body (302, 402, 502, 602). The second electron emitter (306, 506) is spaced apart from the first electron emitter (304, 504). The cathode body (302, 402, 502, 602) defines a first recess (314, 514) and a second recess (316, 516). The first recess (314, 514) includes the first electron emitter (304, 504) positioned at least partially therein and the second recess (316, 516) includes the second electron emitter (306, 506) positioned at least partially therein. The second electron emitter (306, 506) extends further out of the second recess (316, 516) than the first electron emitter (304, 504) extends out of the first recess (314, 514). The first electron emitter (304, 504) and the second electron emitter (306, 506) may be configured to simultaneously direct electrons to a target (128) on an anode (114).

In some aspects, the first electron emitter (304, 504) extends a first distance out of the first recess (314, 514) and the second electron emitter (306, 506) extends a second distance out of the second recess (316, 516), and the difference between the first distance and the second distance is between 5 microns and 25 microns, or the difference between the first distance and the second distance is greater than manufacturing tolerances of the cathode head (300).

In another aspect, the first electron emitter (304, 504) is configured to produce a first focal spot on the target (128) and the second electron emitter (306, 506) is configured to produce a second focal spot on the target (128), and the first focal spot is positioned within the second focal spot. In yet another aspect, the second focal spot is larger than the first focal spot. In a further aspect, the first focal spot overlaps between 70% and 99% of the area of the second focal spot.

In yet another aspect, the first electron emitter (304, 504) and the second electron emitter (306, 506) are substantially the same size. In a further aspect, the first electron emitter (304, 504) is configured to produce a first electron beam and the second electron emitter (306, 506) is configured to produce a second electron beam, and the second electron beam has a larger cross-section than a cross-section of the first electron beam at the target (128).

In a further aspect, the cathode body (302, 402, 502, 602) further defines a third recess (310, 510) and a fourth recess (312, 512). The first recess (314, 514) is positioned within the third recess (310, 510) and the second recess (316, 516) positioned within the fourth recess (312, 512). The third recess (310, 510) is sized and shaped to direct electrons from the first electron emitter (304, 504) to the target (128), and the fourth recess (312, 512) is sized and shaped to direct electrons from the second electron emitter (306, 506) to the target (128).

Further aspects include a power source electrically coupled to the first electron emitter (304, 504) and the second electron emitter (306, 506). The power source is configured to simultaneously direct electrical current to the first electron emitter (304, 504) and the second electron emitter (306, 506) such that the first electron emitter (304, 504) and the second electron emitter (306, 506) simultaneously produce the electrons that are directed to the focal spot on the anode (114).

In further aspects, the first electron emitter (304, 504) and the second electron emitter (306, 506) are angled toward the target (128) on the anode (114).

Further aspects include a focusing structure at least partially surrounding the first electron emitter (304, 504) and the second electron emitter (306, 506). The focusing structure is configured to receive a grid voltage to focus electrons emitted by the first electron emitter (304, 504) and the second electron emitter (306, 506).

Further aspects include a third electron emitter (404, 604) positioned between the first electron emitter (304, 504) and the second electron emitter (306, 506). In some aspects, the third electron emitter (404, 604) includes at least one dimension smaller than the first electron emitter (304, 504) or the second electron emitter (306, 506).

In another embodiment, a cathode (300, 400, 500, 600) for an X-ray tube (100) includes a first electron emitter (304, 504) and a second electron emitter (306, 506). The first electron emitter (304, 504) is oriented to produce a first focal spot on a target (128) of an anode (114). The second electron emitter (306, 506) is spaced apart from the first electron emitter (304, 504) and is oriented to produce a second focal spot on the target (128) of the anode (114). The first focal spot is positioned within the second focal spot, and the second focal spot is larger than the first focal spot.

In some aspects, the first electron emitter (304, 504) and the second electron emitter (306, 506) are substantially the same size.

Further aspects include a focusing grid (520, 540, 620, 640) that is configured to prevent electrons from reaching the first focal spot or the second focal spot when a sufficiently large voltage is applied.

In yet another embodiment, an X-ray tube (100) includes an anode (114) and a cathode (300, 400, 500, 600). The anode (114) includes a target (128). The cathode (300, 400, 500, 600) is spaced apart from the anode (114). The cathode (300, 400, 500, 600) includes a first electron emitter (304, 504), a second electron emitter (306, 506), and a cathode body (302, 402, 502, 602). The first electron emitter (304, 504) is oriented toward the target (128) of the anode (114). The second electron emitter (306, 506) is spaced apart from the first electron emitter (304, 504) and is oriented toward the target (128) of the anode (114). The cathode body (302, 402, 502, 602) defines a first recess (314, 514) and a second recess (316, 516). The first recess (314, 514) includes the first electron emitter (304, 504) positioned at least partially therein and the second recess (316, 516) includes the second electron emitter (306, 506) positioned at least partially therein. The first electron emitter (304, 504) extends a first distance out of the first recess (314, 514), the second electron emitter (306, 506) extends a second distance out of the second recess (316, 516), and the second distance is greater than the first distance.

Further aspects include a power source electrically coupled to the first electron emitter (304, 504) and the second electron emitter (306, 506) to simultaneously direct electrical current to the first electron emitter (304, 504) and the second electron emitter (306, 506) such that the first electron emitter (304, 504) and the second electron emitter (306, 506) simultaneously produce electrons directed to the target (128) of the anode (114).

In further aspects, the first electron emitter (304, 504) is configured to produce a first focal spot on the target (128) and the second electron emitter (306, 506) is configured to produce a second focal spot on the target (128). The second focal spot is larger than the first focal spot and the first focal spot is positioned entirely within the second focal spot. In further aspects, the first electron emitter (304, 504) and the second electron emitter (306, 506) are substantially the same size.

The terms and words used in this description and claims are not limited to the bibliographical meanings, but, are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

What is claimed is:

1. A cathode for an X-ray tube, the cathode comprising:
a first electron emitter;
a second electron emitter spaced apart from the first electron emitter; and
a cathode body defining a first recess and a second recess, the first recess having the first electron emitter positioned at least partially therein and the second recess having the second electron emitter positioned at least partially therein, wherein the second electron emitter extends further out of the second recess than the first electron emitter extends out of the first recess.

2. The cathode of claim 1, wherein the first electron emitter and the second electron emitter are configured to simultaneously direct electrons to a target on an anode.

3. The cathode of claim 1, wherein the first electron emitter extends a first distance out of the first recess and the second electron emitter extends a second distance out of the second recess, and the difference between the first distance and the second distance is greater than manufacturing tolerances for the cathode.

4. The cathode of claim 1, wherein the first electron emitter is configured to produce a first focal spot on the target and the second electron emitter is configured to produce a second focal spot on the target, and the first focal spot is positioned within the second focal spot.

5. The cathode of claim 4, wherein the second focal spot is larger than the first focal spot.

6. The cathode of claim 4, wherein the first focal spot overlaps between 70% and 99% of the area of the second focal spot.

7. The cathode of claim 1, wherein the first electron emitter and the second electron emitter are substantially the same size.

8. The cathode of claim 1, wherein the first electron emitter is configured to produce a first electron beam and the second electron emitter is configured to produce a second electron beam, and the second electron beam has a larger cross-section than a cross-section of the first electron beam at the target.

9. The cathode of claim 1, wherein the cathode body further defines a third recess and a fourth recess, the first recess positioned within the third recess and the second recess positioned within the fourth recess, the third recess sized and shaped to direct electrons from the first electron emitter to the target, and the fourth recess sized and shaped to direct electrons from the second electron emitter to the target.

10. The cathode of claim 1, further comprising a power source electrically coupled to the first electron emitter and the second electron emitter, the power source configured to simultaneously direct electrical current to the first electron emitter and the second electron emitter such that the first electron emitter and the second electron emitter simultaneously produce the electrons that are directed to the focal spot on the anode.

11. The cathode of claim 1, wherein the first electron emitter and the second electron emitter are angled toward the target on the anode.

12. The cathode of claim 1, further comprising a focusing structure at least partially surrounding the first electron emitter and the second electron emitter, the focusing structure configured to receive a grid voltage to focus electrons emitted by the first electron emitter and the second electron emitter.

13. The cathode of claim 1, further comprising a third electron emitter positioned between the first electron emitter and the second electron emitter.

14. The cathode of claim 13, wherein the third electron emitter includes at least one dimension smaller than the first electron emitter or the second electron emitter.

15. A cathode for an X-ray tube, the cathode comprising:
a first electron emitter oriented to produce a first focal spot on a target of an anode; and
a second electron emitter spaced apart from the first electron emitter, the second electron emitter oriented to produce a second focal spot on the target of the anode;
wherein the first focal spot is positioned within the second focal spot, and the second focal spot is larger than the first focal spot.

16. The cathode of claim 15, wherein the first electron emitter and the second electron emitter are substantially the same size.

17. The cathode of claim 15, further comprising a focusing grid that is configured to prevent electrons from reaching the first focal spot or the second focal spot when a sufficiently large voltage is applied.

18. An X-ray tube comprising:
an anode including a target;
a cathode spaced apart from the anode, the cathode comprising:
a first electron emitter oriented toward the target of the anode;
a second electron emitter spaced apart from the first electron emitter, the second electron emitter oriented toward the target of the anode; and
a cathode body defining a first recess and a second recess, the first recess having the first electron emitter positioned at least partially therein and the second recess having the second electron emitter positioned at least partially therein, the first electron emitter extending a first distance out of the first recess, the second electron emitter extending a second distance out of the second recess, wherein the second distance is greater than the first distance.

19. The X-ray tube of claim 18, further comprising a power source electrically coupled to the first electron emitter and the second electron emitter to simultaneously direct electrical current to the first electron emitter and the second electron emitter such that the first electron emitter and the second electron emitter simultaneously produce electrons directed to the target of the anode.

20. The X-ray tube of claim 18, wherein the first electron emitter is configured to produce a first focal spot on the target and the second electron emitter is configured to produce a second focal spot on the target, the second focal spot is larger than the first focal spot, the first focal spot is positioned entirely within the second focal spot, and the first electron emitter and the second electron emitter are substantially the same size.
